(19) United States
(12) Patent Application Publication
(10) Pub. No.: US 2003/0012294 A1
(43) Pub. Date: Jan. 16, 2003

(54) Data communication device and data communication method

(76) Inventors: Sadatoshi Nakamura, Tokyo (JP); Yuzuru Saito, Tokyo (JP); Motofumi Tanabe, Tokyo (JP); Shoichiro Seno, Tokyo (JP)

Correspondence Address: BIRCH STEWART KOLASCH & BIRCH, PO BOX 747, FALLS CHURCH, VA, 22040-0747, US

(21) Appl. No.: 10/181,780

(22) PCT Filed: Sep. 27, 2001
(86) PCT No.: PCT/JP01/08462

(30) Foreign Application Priority Data
Jan. 23, 2001 (JP) 2001-14231

(51) Int. Cl. H04L 27/04

(52) U.S. Cl. 375/295

(57) ABSTRACT

In the case that a plurality of nodes determines a transmission speed prior to point-to-point communication, in order for minimizing a throughput difference between a node with a high transmission speed determined and a node with a low transmission speed determined, the transmission speed recording section 11 of a slave node 1 records a best transmission speed (a maximum transmission speed) for the slave node 1, the transmission speed setting section 12 determines the transmission speed upon negotiation with the master node when starting data transmission, the transmission speed setting section 12 sets a control transmission speed which is the same as or lower than a determined transmission speed based upon the maximum transmission speed and the determined transmission speed. The transmission speed controlling section 13 controls the transmission speed by using a buffer storage 14 so as not to exceed the control transmission speed set by the transmission speed setting section 12.

### TECHNICAL FIELD

This invention relates to a communications technology which enables communication terminals to minimize differences in throughput between/among terminals so as to achieve an impartial band sharing even in a case where the communication terminals sharing the same band communicate with one another by using different levels of transmission speed.

### BACKGROUND ART

FIG. 1 and FIG. 2 are conceptual diagrams illustrating a conventional communications system in accordance with the standard of IEEE 802.11b which appears in the September 2000 issue of the Nikkei Network, for example.

FIG. 1 shows a connection of nodes thereof in relation to the transmission line. FIG. 2 shows a logical connection of the nodes thereof in relation to data flow in communication.

Referring to the figures, reference signs denote slave nodes, a reference numeral 2 denotes a master node, a reference numeral 3 denotes an unstable transmission line, such as that used for a wireless LAN communication and an electric power line communication, on which environmental conditions such as location of terminals may affect transmission speed to vary.

The operation thereof is discussed below.

Each slave node sets a transmission speed upon negotiation with the master node 2 prior to communication.

Normally, transmission speed is determined based upon such as the characteristic of the transmission line 3 between nodes, distance between nodes, obstacles between nodes.

Data outputted from a slave node is always transmitted via the master node regardless of the destination. Then, the data is transmitted to the master node at a set transmission speed.

According to the conventional communication system, the transmission speed between a node and the master node is not constant. This causes a difference in throughput between slave nodes, and results in posing a problem of undermining an impartial band sharing among slave nodes.

This invention is directed to solving such a problem discussed above. It is an objective of the present invention to achieve an impartial band sharing by nodes whose transmission speed is different from each other through minimizing a throughput difference between slave nodes.

### DISCLOSURE OF THE INVENTION

One feature of the data communication device according to the present invention is as follows.

A data communication device for transmitting data to a relay device may include,

a transmission speed recording section for recording a specific transmission speed of itself,

a transmission speed setting section for determining with the relay device a transmission speed applied to data transmission to the relay device prior to the data transmission to the relay device, calculating another transmission speed which is same as or lower than a determined transmission speed determined with the relay device based upon the specific transmission speed recorded in the transmission speed recording section and the determined transmission speed, and setting the another transmission speed calculated as a control transmission speed, and

a transmission speed controlling section for controlling the transmission speed for the data transmission to the relay device so as not to exceed the control transmission speed set by the transmission speed setting section.

The transmission speed setting section may calculate the control transmission speed based upon a value obtained by dividing the specific transmission speed by the determined transmission speed.

The transmission speed recording section may record a maximum transmission speed of itself as the specific transmission speed, and the transmission speed setting section may calculate the control transmission speed based upon the maximum transmission speed recorded in the transmission speed recording section and the determined transmission speed determined with the relay device.

Another feature of the data communication device according to the present invention is as follows.

A data communication device for transmitting data to the relay device may include,

a transmission speed setting section for determining with the relay device a transmission speed applied to data transmission to the relay device prior to the data transmission to the relay device, receiving from the relay device numerical value information about a determined transmission speed determined with the relay device, calculating another transmission speed which is same as or lower than the determined transmission speed based upon the numerical value information received from the relay device, and setting the another transmission speed calculated as a control transmission speed, and

a transmission speed controlling section for controlling the transmission speed for the data transmission to the relay device so as not to exceed the control transmission speed set by the transmission speed setting section.

The relay device may determine with a plurality of data communication devices a transmission speed to be used for data transmission, and the transmission speed setting section of each of data communication devices may receive speed level information indicating a speed level of its determined transmission speed among other data communication devices as the numerical value information, and calculate the control transmission speed based upon the speed level information received.

Another feature of the data communication device according to the present invention is as follows.

A data communication device for transmitting data to a relay device, the data communication device suspending data transmission in a predetermined case and retransmitting the data whose transmission is suspended after a predetermined retransmission wait time elapses, may include,

a transmission speed recording section for recording a specific transmission speed of itself,

a transmission speed setting section for determining with the relay device a transmission speed applied to data transmission to the relay device prior to the data transmission to the relay device, and

a retransmission wait time setting section for setting the retransmission wait time based upon the specific transmission speed recorded in the transmission speed recording section and a determined transmission speed determined by the transmission speed setting section.

The retransmission wait time setting section may set the retransmission wait time based upon a value obtained by dividing the specific transmission speed by the determined transmission speed.

The transmission speed recording section may record a maximum transmission speed of itself as the specific transmission speed, and the retransmission wait time setting section may set the retransmission wait time based upon the maximum transmission speed recorded in the transmission speed recording section and the determined transmission speed determined with the relay device.

Another feature of the data communication device according to the present invention is as follows.

A data communication device for transmitting data to a relay device, the data communication device suspending data transmission in a predetermined case and retransmitting the data whose transmission is suspended after a predetermined retransmission wait time elapses, may include,

a transmission speed setting section for determining with the relay device a transmission speed applied to data transmission to the relay device prior to the data transmission to the relay device, and receiving from the relay device numerical value information about a determined transmission speed determined with the relay device, and

a retransmission wait time setting section for setting the retransmission wait time based upon the numerical value information received by the transmission speed setting section.

The relay device may determine with a plurality of data communication devices a transmission speed to be used for data transmission.

The transmission speed setting section of each of the data communication devices may receive speed level information indicating a speed level of its determined transmission speed among other data communication devices as the numerical value information.

The retransmission wait time setting section of each of communication devices may set the retransmission wait time based upon the speed level information received by the transmission speed setting section.

Another feature of the data communication device according to the present invention is as follows.

A data communication method for transmitting data to a relay device may include,

transmission speed recording step for recording a specific transmission speed of itself,

transmission speed setting step for determining with the relay device a transmission speed applied to data transmission to the relay device prior to the data transmission to the relay device, calculating another transmission speed which is same as or lower than a determined transmission speed determined with the relay device based upon the specific transmission speed recorded in the transmission speed recording step and the determined transmission speed, and setting the another transmission speed calculated as a control transmission speed, and

transmission speed controlling step for controlling the transmission speed for the data transmission to the relay device so as not to exceed the control transmission speed set in the transmission speed setting step.

Another feature of the data communication device according to the present invention is as follows.

A data communication method for transmitting data to the relay device may include,

transmission speed setting step for determining with the relay device a transmission speed applied to data transmission to the relay device prior to the data transmission to the relay device, receiving from the relay device numerical value information about a determined transmission speed determined with the relay device, calculating another transmission speed which is same as or lower than the determined transmission speed based upon the numerical value information received from the relay device, and setting the another transmission speed calculated as a control transmission speed, and

transmission speed controlling step for controlling the transmission speed for the data transmission to the relay device so as not to exceed the control transmission speed set in the transmission speed setting step.

Another feature of the data communication device according to the present invention is as follows.

A data communication method for transmitting data to a relay device, the data communication method suspending data transmission in a predetermined case and retransmitting the data whose transmission is suspended after a predetermined retransmission wait time elapses, may include,

transmission speed recording step for recording a specific transmission speed of itself,

transmission speed setting step for determining with the relay device a transmission speed applied to data transmission to the relay device prior to the data transmission to the relay device, and

retransmission wait time setting step for setting the retransmission wait time based upon the specific transmission speed recorded in the transmission speed recording step and a determined transmission speed determined in the transmission speed setting step.

Another feature of the data communication device according to the present invention is as follows.

A data communication method for transmitting data to a relay device, the data communication method suspending data transmission in a predetermined case and retransmitting the data whose transmission is suspended after a predetermined retransmission wait time elapses, may include,

transmission speed setting step for determining with the relay device a transmission speed applied to data transmission to the relay device prior to the data transmission to the relay device, and receiving from the relay device numerical value information about a determined transmission speed determined with the relay device, and

retransmission wait time setting step for setting the retransmission wait time based upon the numerical value information received in the transmission speed setting step.

### BRIEF DESCRIPTION OF THE DRAWINGS

FIG. 1 is a block diagram of a communication system which includes a slave node according to an embodiment of this invention;

FIG. 2 is a block diagram of a communication system which includes a slave node according to an embodiment of this invention;

FIG. 3 is an operational flow for transmitting data by a slave node used in a first embodiment and a second embodiment of this invention;

FIG. 4 is an operational flow in the master node for determining a transmission speed of the master node and a slave node according to the second embodiment and a fourth embodiment of this invention;

FIG. 5 is a diagram illustrating a configuration of a slave node; and

FIG. 6 is a diagram illustrating a configuration of a slave node.

### BEST MODE FOR CARRYING OUT THE INVENTION

Embodiment 1.

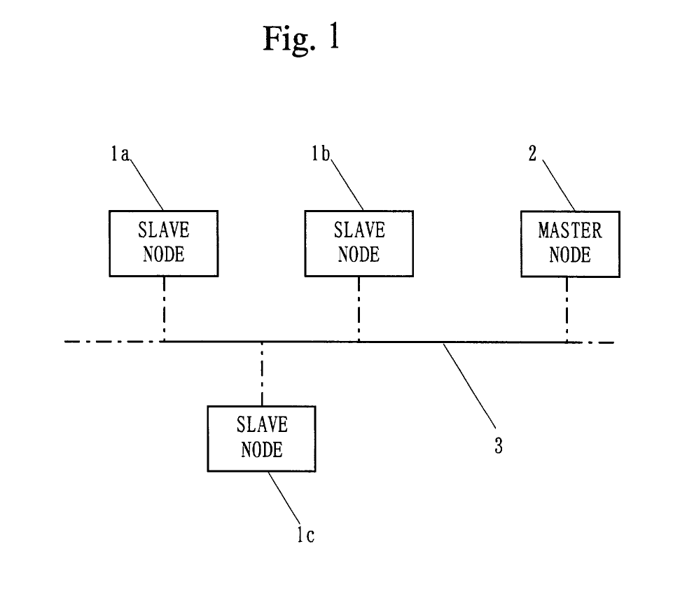

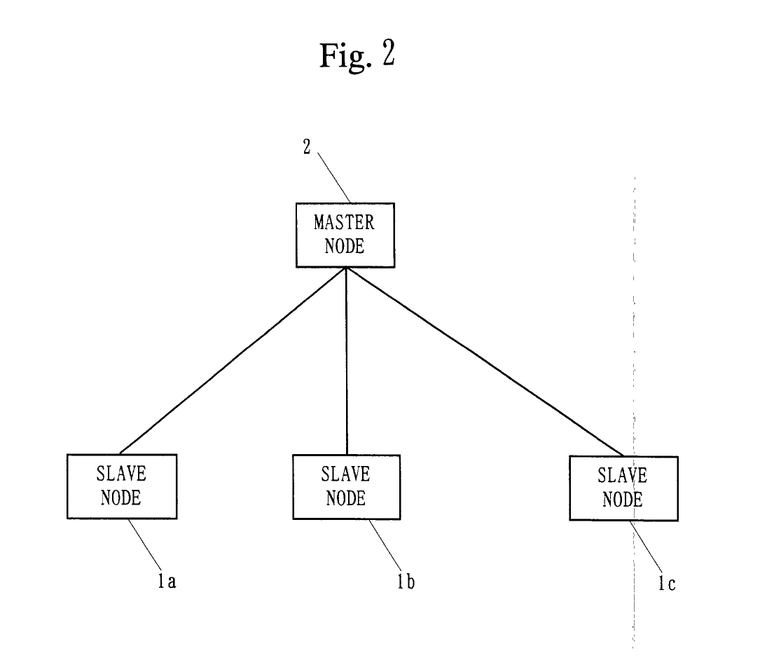

FIG. 1 and FIG. 2, which are commonly used to discuss the conventional example, illustrates the configuration of the communication system according to this invention. Specifically, the slave node 1 acts as a data communication device, the master mode 2 acts as a relay device, and the transmission line 3 connects the slave node 1 and the master node 2.

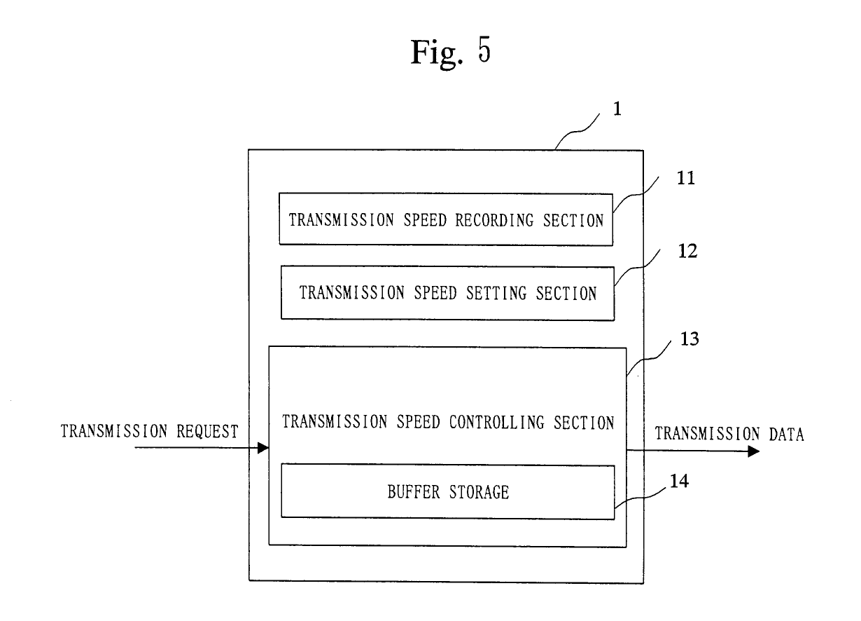

FIG. 5 is a diagram illustrating the configuration of the slave node 1 according to a first embodiment.

Referring to FIG. 5, a reference numeral 11 denotes a transmission speed recording section which records a best transmission speed (a maximum transmission speed) of a slave node which is based on the specification of the transmission line. A reference numeral 12 denotes a transmission speed setting section which determines a transmission speed upon negotiation with the master node when starting communication, and sets a control transmission speed, which is the same or lower than a determined transmission speed, based upon the maximum transmission speed and the determined transmission speed. A reference numeral 13 denotes a transmission speed controlling section which controls the transmission speed so as not to exceed the control transmission speed set by the transmission speed setting section 12. A reference numeral 14 denotes a buffer storage, which is provided in the transmission speed controlling section 13, stores data temporally so as to adjust the flow rate of the data.

An operation thereof is discussed below.

Firstly, when starting communication, the transmission speed setting section 12 of the slave node 1 determines upon negotiation with the master node a transmission speed in compliance with a channel condition.

Then, the transmission speed setting section 12 calculates a limited transmission speed based upon the determined transmission speed in accordance with an equation 1 below.

control transmission speed=f(best transmission speed/actual transmission speed) (Equation 1)

It is to be noted that the best transmission speed means a maximum transmission speed which is recorded in the transmission speed recording section 11, and the actual transmission speed is the determined transmission speed upon negotiation between the transmission speed setting section 12 and the master node 2.

Also, f(x) is a monotone increasing function. For that reason, the higher the actual transmission speed is, the lower the limited transmission speed becomes.

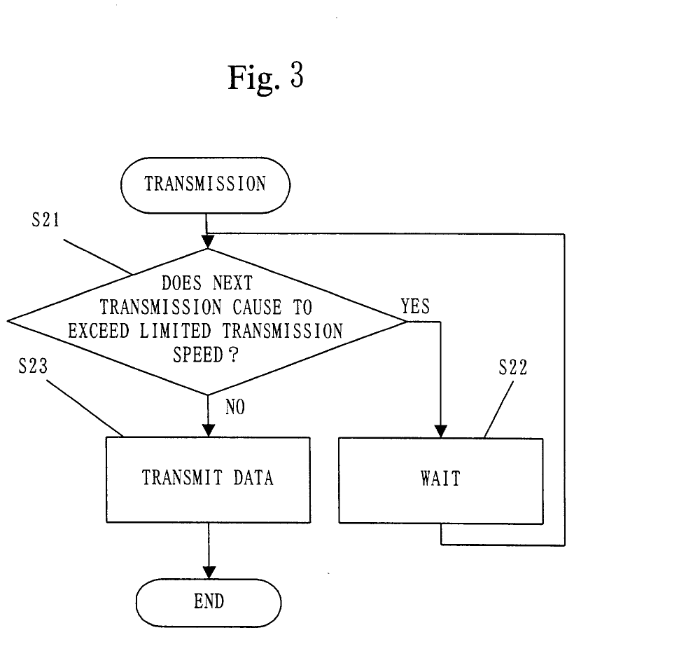

After the control transmission speed is set through the operation discussed above, an actual operation for transmitting data is performed as shown in FIG. 3.

Firstly, the transmission speed controlling section 13 examines whether or not the transmission of the data causes the transmission speed to exceed limited transmission speed at the previous unit time (S21).

Secondly, if the transmission speed is to exceed the limited transmission speed, then the transmission speed controlling section 13 suspends transmitting for a predetermined period of time (S22) and repeats the process of S21.

The WAIT operation of S22 is performed by the buffer storage 14 storing the data temporarily. This allows to control the flow rate of the data so as to adjust the transmission speed to be the same as or lower than the control transmission speed.

If the transmission speed is not to exceed the limited transmission speed, then the operation terminates after transmitting the data (S23).

By thus controlling the amount of transmission of high speed terminals, transmission opportunities available for low speed terminals sharing the same band with the high speed terminals may be increased. As a result, the throughput difference between/among terminals may be minimized.

Embodiment 2.

In the first embodiment, the value of flow limit is calculated based on the ratio of the ideal speed of the communication channel (the maximum transmission speed). In another embodiment, however, the flow rate is limited upon consideration of transmission speed of all of the slave nodes connected with the master node.

The configuration of a system according to this embodiment is the same as that of the first embodiment as shown in FIG. 1 and FIG. 2.

Also, the configuration of the slave node 1 is the same as that of the first embodiment as shown in FIG. 5.

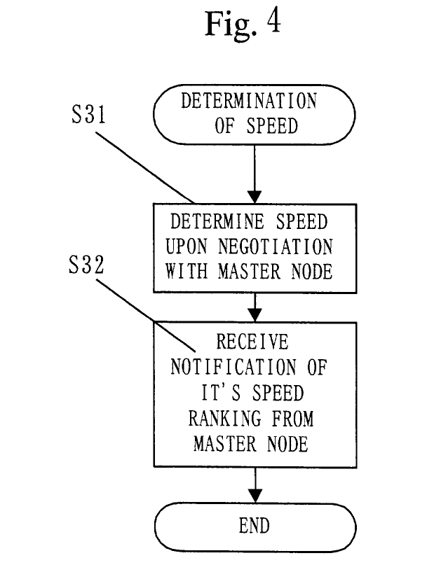

FIG. 3 is the operational flow of the slave node for transmission which is the same as that of the first embodiment. FIG. 4 is an operational flow for determining the transmission speed upon negotiation between the master node and a slave node.

An operation thereof is discussed below.

The slave node 1 operates according to the flow of FIG. 4 for determining the transmission speed.

Firstly, the transmission speed setting section 12 of the slave node 1 determines the transmission speed upon negotiation with the master node 2 (S31). Then, the transmission speed setting section 12 receives from the master node 2 speed level information which notifies how high the self transmission speed is among the transmission speed of each slave node determined by the master node 2 (S32).

Secondly, the transmission speed setting section 12 of the slave node, upon notification of the ranking, calculates the limited transmission speed in accordance with an equation 2 below.

control transmission speed=g(transmission speed ranking) (Equation 2)

It is to be noted that this function g(x) is a monotone increasing function. For that reason, the higher the ranking is of a slave node, the lower the limited transmission speed becomes.

After the control transmission speed is set through the operation discussed above, an actual operation for transmitting data is performed as shown in FIG. 3. The details of the operation are the same as those discussed in the first embodiment.

Thus by controlling the amount of transmission of high speed terminals, transmission opportunities available for low speed terminals sharing the same band with the high speed terminals may be increased. As a result, the throughput difference between/among terminals may be minimized. The characteristic of the minimization is thus different from that of the first embodiment, and therefore may suit more for some systems than that of the first embodiment, depending upon the characteristics of systems.

Embodiment 3.

An operation according to a third embodiment is discussed below.

This embodiment is the same as the first embodiment in an aspect that the ratio to the best transmission speed of the communication channel (the maximum transmission speed) is used. However, instead of using the flow limit per unit time, the value of a retransmission timer to be used for the CSMA (Carrier Sense Multiple Access) function is varied to increase or decrease a transmission opportunity for each terminal.

The configuration of a system according to this embodiment is the same as that of the first and second embodiments as shown in FIG. 1 and FIG. 2.

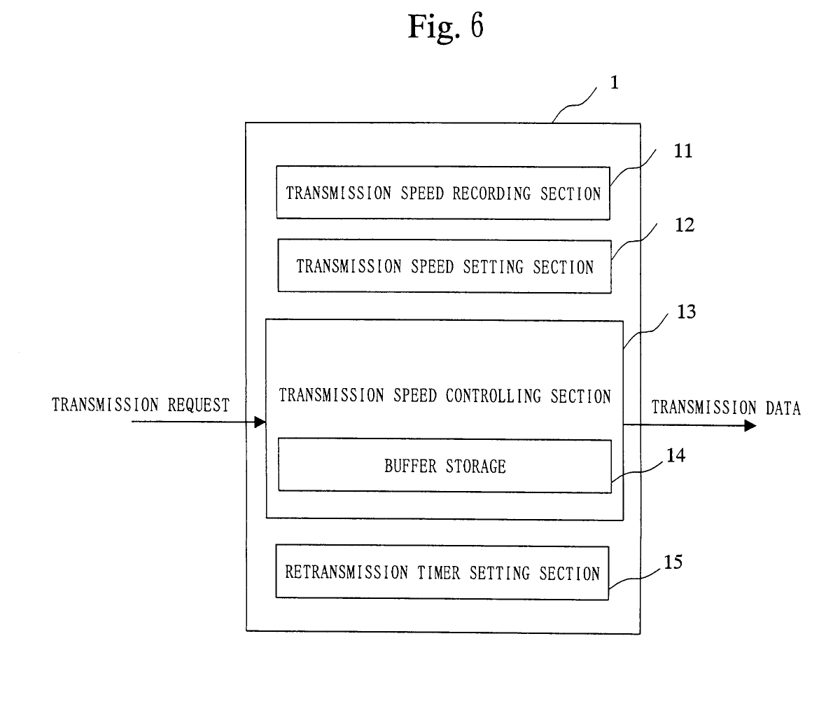

FIG. 6 is a diagram illustrating a configuration of the slave node 1 according to this embodiment.

With referring to FIG. 6, reference numerals 11 through 14 denote the same elements of the slave node 1 as those discussed in the first embodiment. A reference numeral 15 denotes a retransmission timer value setting section (a retransmission wait time setting section) for setting a value of the retransmission timer (retransmission wait time) to be used for the CSMA function.

An operation thereof is discussed below.

Firstly, the transmission speed setting section 12 of the slave node 1 determines the transmission speed depending upon the channel condition upon negotiation with the master node when starting communication.

Secondly, a timer coefficient is calculated in accordance with an equation 3 below based upon the determined transmission speed.

retransmission timer coefficient=h (best transmission speed/actual transmission speed) (Equation 3)

With this equation, h(x) is a monotone decreasing function. For that reason, the higher the actual transmission speed is, the larger the timer coefficient becomes.

The retransmission timer value setting section 15, after determining the retransmission timer coefficient through the operation discussed above, sets a value as the retransmission timer value, the value is obtained by multiplying a random number value, which is generated as a suspension timer when sensing carriers from other nodes, by the timer coefficient. The transmission speed controlling section 13, in the case of suspending data transmission, performs retransmission control based upon the retransmission timer value set by the retransmission timer setting section 15.

Thus by controlling the amount of transmission of high speed terminals, transmission opportunities available for low speed terminals sharing the same band with the high speed terminals may be increased. As a result, the throughput difference between/among terminals may be minimized.

The characteristic of the minimization is thus different from that of the first and second embodiment, and therefore may suit most for some systems depending upon the characteristics of systems. Also, in many cases, the retransmission timer may be accomplished with more simple mechanism than the case of limiting the flow of traffic discussed in the first and second embodiments.

Embodiment 4.

An operation according to a fourth embodiment is discussed below.

This embodiment is the same as the second embodiment in one aspect that the transmission speed ranking of all the terminals is used. However, instead of using flow limit per unit time, the retransmission timer value to be used for the CSMA function is varied to increase or decrease the transmission opportunity of each terminal.

The configuration of a system according to this embodiment is the same as that employed in the first through third embodiments as shown in FIG. 1 and FIG. 2.

The configuration of the slave node 1 according to this embodiment is the same as that of the third embodiment shown in FIG. 6.

Also in this embodiment, like the second embodiment, an operational flow for determining the transmission speed upon negotiation between the slave node 1 and the master node 2 is shown in FIG. 4.

An operation thereof is discussed below.

When determining the transmission speed, the slave node 1 and the master node 2 operates in accordance with the flow of FIG. 4. The details of the operation are the same as those discussed in the second embodiment.

Then, the retransmission timer coefficient is calculated in accordance with an equation 4 below based upon the determined transmission speed.

retransmission timer coefficient=I(transmission speed ranking) (Equation 4)

With this equation, I(x) is a monotone decreasing function. For that reason, the higher the actual ranking is, the larger the timer coefficient becomes.

The retransmission timer value setting section 15, after determining the retransmission timer coefficient through the operation discussed above, sets a value as the retransmission timer value, the value is obtained by multiplying a random number value, which is generated as a suspension timer when sensing carriers from other nodes, by the timer coefficient. The transmission speed controlling section 13, in the case of suspending data transmission, performs retransmission control based upon the retransmission timer value set by the retransmission timer setting section 15.

By thus increasing or decreasing the value of the retransmission timer of the slave node, transmission opportunities for high speed terminals may be decreased and transmission opportunities for low speed terminals may be increased. As a result, the throughput difference between/among terminals may be minimized.

The characteristic of the minimization is thus different from that of the respective first, second and third embodiment, and therefore may suit most for some systems depending upon the characteristics of systems. Also, in many cases, the retransmission timer may be accomplished with more simple mechanism than the case of limiting the flow of traffic discussed in the first and second embodiments.

With further reference to the first through fourth embodiments, the explanation was directed to the communication system which includes the data communication device according to the present invention. However, through the same procedures as those discussed with the communication system, a data communication method according to the present invention may be implemented.

Now, the characteristics of the present invention discussed heretofore may be epitomized as below.

One characteristic of the communication system relates to the present invention is as follows. In the communication system, a plurality of communication devices is connected to one another on the transmission line, which is an unstable transmission line whose communication channel characteristics vary depending upon such as the location of terminals. The plurality of communication devices transmits and receives data preventing the collision of signals by adjusting the transmission timing of the data based upon the detection result of carrier signals from other communication devices and the retransmission timer for generating random time for suspension of transmission and for retransmission depending upon the detection result.

Furthermore, one of the plurality of communication devices is set to be the master node and the others are set to be the slave nodes in the communication method which establishes the logical star structure to carry out communication.

In the communication method, each slave node is characterized with having means for calculating the ratio of the self transmission speed to the transmission speed in a physically best condition, calculating the throughput per unit time to be kept based upon the value of the ratio, and keeping the calculated throughput.

In other words, according to the communication system relating to the present invention, the ratio of the actual transmission speed of the slave node to the best transmission speed calculated based upon the specification of the transmission line is considered the predominance of the slave node. Then, each slave node performs communication at the flow rate corresponding to the predominance.

Another characteristic of the communication system relates to the present invention is as follows. In the communication system, a plurality of communication devices is connected to one another on the transmission line, which is an unstable transmission line whose communication channel characteristics vary depending upon such as the location of terminals. The plurality of communication devices, each provided with the facility of sensing carrier signals from other communication devices, transmits and receives data preventing the collision of signals by adjusting the transmission timing of the data based upon the detection result of carrier signals from other communication devices and the retransmission timer for generating random time for suspension of transmission and for retransmission depending upon the detection result.

Furthermore, one of the plurality of communication devices is set to be the master node and the others are set to be the slave nodes in the communication method which establishes the logical star structure to carry out communication.

In the communication method, each slave node is characterized with having means being notified that the slave node is the Nth in ranking of transmission speed of all the slave nodes sharing the same band of communication and means for keeping the predetermined throughput per unit time based upon the value of N.

In other words, according to the communication system relating to the present invention, the ranking of the real transmission speed of the slave node among all the slave nodes sharing the same band of communication is considered the predominance of the slave node. Then, each slave node performs communication at the flow rate corresponding to the predominance.

Still another characteristic of the communication system relates to the present invention is as follows. In the communication system, a plurality of communication devices is connected to one another on the transmission line, which is an unstable transmission line whose communication channel characteristics vary depending upon such as the location of terminals. The plurality of communication devices, each provided with the facility of sensing carrier signals from other communication devices, transmits and receives data preventing the collision of signals by adjusting the transmission timing of the data based upon the detection result of carrier signals from other communication devices and the retransmission timer for generating random time for suspension of transmission and for retransmission depending upon the detection result.

Furthermore, one of the plurality of communication devices is set to be the master node and the others are set to be the slave nodes in the communication method which establishes the logical star structure to carry out communication.

In the communication method, each slave node is characterized with having means for calculating the ratio of the self transmission speed to the transmission speed in a physically best condition, and increasing or decreasing the coefficient of the value of the retransmission timer based upon the value of the ratio.

In other words, according to the communication system relating to the present invention, the ratio of the actual transmission speed of the slave node to the best transmission speed calculated based upon the specification of the transmission line is considered the predominance of the slave node. Then, each slave node is to increase or decrease the value of the retransmission timer depending upon its own predominance.

Still another characteristic of the communication device relates to the present invention is as follows. In the communication system, a plurality of communication devices is connected to one another on the transmission line, which is an unstable transmission line whose communication channel characteristics vary depending upon such as the location of terminals. The plurality of communication devices, each provided with the facility of sensing carrier signals from other communication devices, transmits and receives data preventing the collision of signals by adjusting the transmission timing of the data based upon the detection result of carrier signals from other communication devices and the retransmission timer for generating random time for suspension of transmission and for retransmission depending upon the detection result.

Furthermore, one of the plurality of communication devices is set to be the master node and the others are set to be the slave nodes in the communication method which establishes the logical star structure to carry out communication.

In the communication method, each slave node is characterized with having means for being notified that the slave node is the Nth in ranking of transmission speed of all the slave nodes sharing the same band of communication and means for increasing or decreasing the coefficient of the value of the retransmission timer based upon the value of N.

In other words, according to the communication system relating to the present invention, the ranking of the real transmission speed of the slave node among all the slave nodes sharing the same band of communication is considered the predominance. Then, the value of the retransmission timer is increased or decreased based upon the predominance.

### INDUSTRIAL APPLICABILITY

As above, according to the best mode for carrying out the present invention, each slave node, upon negotiation with the master node, gets to know how fast its own actual transmission speed is in comparison with the ideal transmission speed and then controls the flow rate in accordance with the degree if the speed is high. As a result, a communication system, which is more impartial for all the slave nodes sharing the same band, may be provided.

In addition to that, according to the best mode for carrying out the present invention, each slave node gets to know its ranking of the transmission speed to the master node among all the slave nodes sharing the same band and then controls the flow rate in accordance with the speed ranking if the speed is high. As a result, a communication system, which is more impartial for all the slave nodes sharing the same band, may be provided.

In addition to that, according to the best mode for carrying out the present invention, each slave node, upon negotiation with the master node, gets to know how fast it's actual transmission speed is in comparison with the ideal transmission speed and then decreases the transmission opportunities of the self node by making the period of the retransmission timer longer in accordance with the speed ranking if the speed is high. As a result, a communication system, which is more impartial for all the slave nodes sharing the same band, may be provided.

In addition to that, according to the best mode for carrying out the present invention, each slave node gets to know the ranking of the transmission speed to the master node of the slave node among all the slave nodes sharing the same band and then decreases the transmission opportunities of the self node by making the period of the retransmission timer longer in accordance with the speed ranking if the speed is high. As a result, a communication system, which is more impartial for all the slave nodes sharing the same band, may be provided.

1. A data communication device for transmitting data to a relay device, the data communication device comprising:
a transmission speed recording section for recording a specific transmission speed of itself;
a transmission speed setting section for determining with the relay device a transmission speed applied to data transmission to the relay device prior to the data transmission to the relay device, calculating another transmission speed which is same as or lower than a determined transmission speed determined with the relay device based upon the specific transmission speed recorded in the transmission speed recording section and the determined transmission speed, and setting the another transmission speed calculated as a control transmission speed; and
a transmission speed controlling section for controlling the transmission speed for the data transmission to the relay device so as not to exceed the control transmission speed set by the transmission speed setting section.

2. The data communication device according to claim 1, wherein the transmission speed setting section calculates the control transmission speed based upon a value obtained by dividing the specific transmission speed by the determined transmission speed.

3. The communication device according to claim 1, wherein the transmission speed recording section records a maximum transmission speed of itself as the specific transmission speed; and
wherein the transmission speed setting section calculates the control transmission speed based upon the maximum transmission speed recorded in the transmission speed recording section and the determined transmission speed determined with the relay device.

4. A data communication device for transmitting data to the relay device, the data communication device comprising:
a transmission speed setting section for determining with the relay device a transmission speed applied to data transmission to the relay device prior to the data transmission to the relay device, receiving from the relay device numerical value information about a determined transmission speed determined with the relay device, calculating another transmission speed which is same as or lower than the determined transmission speed based upon the numerical value information received from the relay device, and setting the another transmission speed calculated as a control transmission speed; and
a transmission speed controlling section for controlling the transmission speed for the data transmission to the relay device so as not to exceed the control transmission speed set by the transmission speed setting section.

5. The data communication device according to claim 4, wherein the relay device determines with a plurality of data communication devices a transmission speed to be used for data transmission; and
wherein the transmission speed setting section of each of data communication devices receives speed level information indicating a speed level of its determined transmission speed among other data communication devices as the numerical value information, and calculates the control transmission speed based upon the speed level information received.

6. A data communication device for transmitting data to a relay device, the data communication device suspending data transmission in a predetermined case and retransmitting the data whose transmission is suspended after a predetermined retransmission wait time elapses, the data communication device comprising:
a transmission speed recording section for recording a specific transmission speed of itself;
a transmission speed setting section for determining with the relay device a transmission speed applied to data transmission to the relay device prior to the data transmission to the relay device; and
a retransmission wait time setting section for setting the retransmission wait time based upon the specific transmission speed recorded in the transmission speed recording section and a determined transmission speed determined by the transmission speed setting section.

7. The data communication device according to claim 6, wherein the retransmission wait time setting section sets the retransmission wait time based upon a value obtained by dividing the specific transmission speed by the determined transmission speed.

8. The data communication device according to claim 6, wherein the transmission speed recording section records a maximum transmission speed of itself as the specific transmission speed, and
wherein the retransmission wait time setting section sets the retransmission wait time based upon the maximum transmission speed recorded in the transmission speed recording section and the determined transmission speed determined with the relay device.

9. A data communication device for transmitting data to a relay device, the data communication device suspending data transmission in a predetermined case and retransmitting the data whose transmission is suspended after a predetermined retransmission wait time elapses, the data communication device comprising:
a transmission speed setting section for determining with the relay device a transmission speed applied to data transmission to the relay device prior to the data transmission to the relay device, and receiving from the relay device numerical value information about a determined transmission speed determined with the relay device; and
a retransmission wait time setting section for setting the retransmission wait time based upon the numerical value information received by the transmission speed setting section.

10. The data communication device according to claim 9, wherein the relay device determines with a plurality of data communication devices a transmission speed to be used for data transmission,
wherein the transmission speed setting section of each of the data communication devices receives speed level information indicating a speed level of its determined transmission speed among other data communication devices as the numerical value information, and
wherein the retransmission wait time setting section of each of communication devices sets the retransmission wait time based upon the speed level information received by the transmission speed setting section.

11. A data communication method for transmitting data to a relay device, the data communication method comprising:
transmission speed recording step for recording a specific transmission speed of itself;
transmission speed setting step for determining with the relay device a transmission speed applied to data transmission to the relay device prior to the data transmission to the relay device, calculating another transmission speed which is same as or lower than a determined transmission speed determined with the relay device based upon the specific transmission speed recorded in the transmission speed recording step and the determined transmission speed, and setting the another transmission speed calculated as a control transmission speed; and
transmission speed controlling step for controlling the transmission speed for the data transmission to the relay device so as not to exceed the control transmission speed set in the transmission speed setting step.

12. A data communication method for transmitting data to the relay device, the data communication method comprising:
transmission speed setting step for determining with the relay device a transmission speed applied to data transmission to the relay device prior to the data transmission to the relay device, receiving from the relay device numerical value information about a determined transmission speed determined with the relay device, calculating another transmission speed which is same as or lower than the determined transmission speed based upon the numerical value information received from the relay device, and setting the another transmission speed calculated as a control transmission speed; and
transmission speed controlling step for controlling the transmission speed for the data transmission to the relay device so as not to exceed the control transmission speed set in the transmission speed setting step.

13. A data communication method for transmitting data to a relay device, the data communication method suspending data transmission in a predetermined case and retransmitting the data whose transmission is suspended after a predetermined retransmission wait time elapses, the data communication method comprising:
transmission speed recording step for recording a specific transmission speed of itself;
transmission speed setting step for determining with the relay device a transmission speed applied to data transmission to the relay device prior to the data transmission to the relay device; and
retransmission wait time setting step for setting the retransmission wait time based upon the specific transmission speed recorded in the transmission speed recording step and a determined transmission speed determined in the transmission speed setting step.

14. A data communication method for transmitting data to a relay device, the data communication method suspending data transmission in a predetermined case and retransmitting the data whose transmission is suspended after a predetermined retransmission wait time elapses, the data communication device comprising:
transmission speed setting step for determining with the relay device a transmission speed applied to data transmission to the relay device prior to the data transmission to the relay device, and receiving from the relay device numerical value information about a determined transmission speed determined with the relay device; and
retransmission wait time setting step for setting the retransmission wait time based upon the numerical value information received in the transmission speed setting step.
